(19) United States
(12) Patent Application Publication
(10) Pub. No.: US 2017/0326476 A1
(43) Pub. Date: Nov. 16, 2017

(54) METHOD AND APPARATUS FOR REMOVAL OF CLARIFIED LIQUID

(71) Applicant: FINNCHAIN OY, Rauma (FI)

(72) Inventor: Pekka Tuomikoski, Rauma (FI)

(73) Assignee: FINNCHAIN OY, Rauma (FI)

(21) Appl. No.: 15/523,153

(22) PCT Filed: Oct. 12, 2015
(86) PCT No.: PCT/FI2015/050682

§ 371 Date: Apr. 28, 2017

(30) Foreign Application Priority Data
Nov. 4, 2014 (FI) 20145961

(51) Int. Cl. B01D 21/24; B01D 21/04; B01D 21/30; B01D 21/34

(52) U.S. Cl. CPC B01D 21/2444; B01D 21/34; B01D 21/04; B01D 21/302

(57) ABSTRACT

The invention relates first of all to a method for removal of clarified liquid from a liquid basin (N), such as a clarification basin or like, with an apparatus, by means of which clarified liquid is being removed by using a liquid exhaust arrangement (2) and a collecting arrangement coupled therewith. The liquid exhaust arrangement comprises one or more exhaust passages (2a1), existing beneath surface (y) of the liquid basin one after another in longitudinal direction (s) of the liquid basin and comprising a profile with an essentially closed cross section, such as a pipe, channel or like, each passage having a perforation (R) to make possible flow of liquid inside the same. Functioning of the liquid exhaust arrangement is being controlled according to the circumstances, such as due to surface alteration in the liquid basin, by adjusting the amount of liquid to be removed by the exhaust passage (2a1) by changing a flow cross section area beneath the surface (y) of the liquid basin of an open overflow edge (2a2y) of exhaust organs (2a2), being coupled with the perforation (R) in the exhaust passage and having a cross section expanding towards outer end thereof, which is carried out by turning (w) the exhaust organs (2a2) with respect to longitudinal axis (p1) of the exhaust passage (2a1). The invention also relates to an apparatus operating according to the method.

The invention relates to a method and an apparatus for removal of clarified liquid from a liquid basin, such as a clarification tank or like, the method and apparatus being defined in the preambles of the independent claims directed to the same.

A traditional solution in the purpose described above and particularly in square shaped basins is of the kind that in processing fluid, such as waste water in a liquid basin, an apparatus is being used, which, in order to bring about a required flow in the liquid basin, comprises when carried out traditionally typically a scraper bar arrangement, which has several scraper bars, existing one after the other in longitudinal direction of the basin, and movement means for moving the same, such as two chains, being parallel and driven by a drive wheel and an idle wheel assembly, in connection with which the scraper bars are fastened removably particularly in order to make easier service and maintenance of the scraper bar arrangement. The type of scraper bar arrangements mentioned above are nowadays being used e.g. in connection with clarification tanks so that the scraper bars are driven by chains, moving at opposite sides or intermediate walls of the tank, alternatively in opposite directions so that while moving along the bottom they scrape sludge existing at the bottom to a sludge pocket, and respectively while moving in the other direction they guide passage of the liquid in the liquid basin. There are also scraper bar systems, in which the bars are being moved e.g. by a carriage that moves above the tank or e.g. by hydraulic arrangements, or on the other hand also flow guidance arrangements that are carried out without actual scrapers. In such a case, the tank may also be in practice almost of whatever shape.

If in connection with the processing described above surface scum gets collected on the surface of the liquid basin, it is removed particularly in square shaped basins usually in a so to speak indirect manner, so that movement of the scrapers guide the material on the surface toward a collecting chute in a so to speak free-drifting manner. The collecting chutes, being traditionally used in this connection, are usually mechanically operated “suction chutes”, which are being turned from time to time around a longitudinal axis to a position, in which the surface scum is being “gulped” inside the same in order to subsequently lead it away from the liquid basin. On the other hand, in this connection also a suction chute is used, which has a moveable front wall, the operating principle of which is, however, in practice the same as described above. In addition to the mechanical removal of surface scum, applications based on overflow are also being used, by means of which excessive gathering of surface scum on the surface can be prevented at its best with a smaller amount of escort water than by using customary chutes.

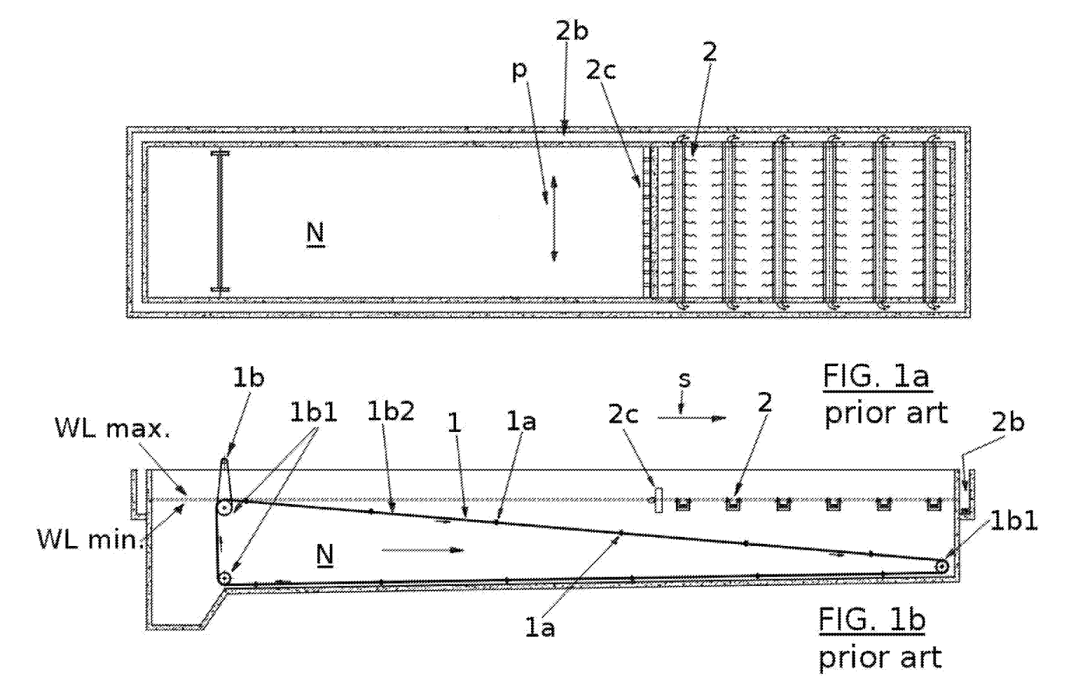

In a clarifying section particularly of the type of process described above, traditionally a type of implementation e.g. as shown in FIGS. 1a, 1b has been used for the removal of clarified liquid, wherein in the clarifying section existing in the liquid basin after the exhaust arrangement of the surface scum, overflow chutes in crosswise direction are being placed one after another in the longitudinal direction of the liquid basin, into which liquid being clarified on the surface of the liquid basin may get drifted, typically by flowing over in the longitudinal direction opposite overflow edges thereof. The overflow chutes are coupled typically by opposite ends thereof to a collecting chute, by means of which clarified liquid is being furthermore removed from the liquid basin.

The opposite overflow edges of the type of overflow chutes described above furthermore comprise overflow grooves that narrow downward e.g. conically, by means of which it is made possible when the level of the liquid basin alters between its maximum and minimum values that clarified liquid gets drifted into the overflow chutes the more the higher the liquid surface is.

A problem in practise in use of the type of overflow chutes described above is the fact that an ideal movement continuing as a one-directional flow of the liquid surface in the liquid basin is interrupted, because the overflow chutes are on the level of the liquid surface and the surface liquid drifts therein from opposite sides thereof. Due to the above, liquid surface between the overflow chutes may remain in places in a stagnant state, which is why e.g. nutrients in waste water are able to perform growth and block the overflow edges of the chutes in question. For this reason, the need for cleaning of this type of overflow chutes is usually high. On the other hand, particularly in connection with liquid basins in open spaces, noise caused by the flow into the open overflow chutes may also be experienced harmful.

Furthermore, because the types of overflow chutes described above are stationary, placement thereof in the liquid basin is always continuously the same. This is why situations occur when the liquid height in the liquid basin alters that the surface liquid may stay longer periods in a stagnant state, which is why e.g. nutrition may get gathered on the surface causing growth and increasing blockages in the overflow chutes. Furthermore, because traditional overflow chutes are open structures, they need to be very stiff in order to withstand pressure caused by the liquid basin. Due to the above the overflow chutes in question are usually manufactured from concrete or steel, which is why manufacturing costs thereof are usually very high.

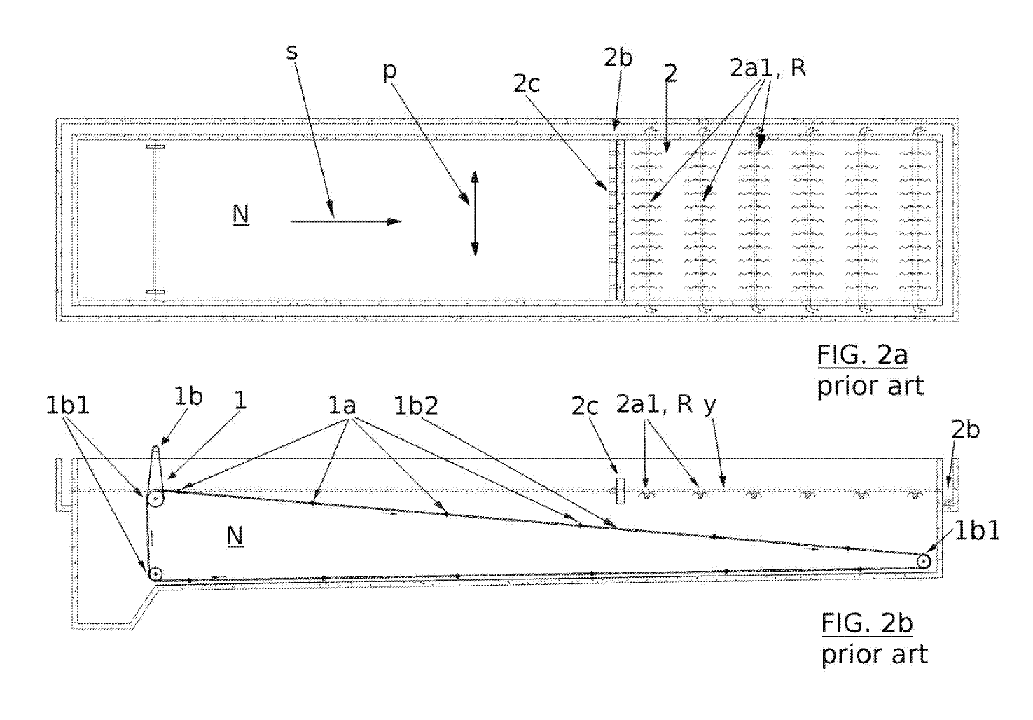

On the other hand, at present also the type of implementations as shown in FIGS. 2a, 2b are being used, in which the removal of clarified liquid takes place by several, beneath the surface of the liquid basin one after another in the longitudinal direction of the liquid basin existing exhaust pipes comprising a profile with an essentially closed cross section, each pipe having a perforation to make possible flow of liquid inside the same.

An advantage of this type of implementation is the fact that a continuous movement of the liquid surface in the clarifying section of the liquid basin is achieved thanks to the liquid on the surface moving off through holes in the exhaust pipes existing under normal operating situations below the liquid surface, in which context also noise being caused by the flow into an open surface chute can be avoided.

The biggest problem in this type of an implementation is first of all that that with this kind of exhaust pipes it is not in any way possible to react to the alteration of the surface level in the liquid basin, which is why they must be placed deep down enough below the liquid surface so that clarified liquid may still be removed at the minimum surface level of the liquid basin. Due to the exhaust pipes being according to customary overflow chutes stationary, similar problems are caused by the same in that respect as explained above regarding the overflow chutes.

Therefore, the functioning of clarifying sections especially in the type of liquid basins described in the beginning and being carried out according to present technique is not in practise at a sufficiently good level, which is why the functioning of such processes is not at present possible to carry out optimally in every respect.

It is the aim of the method and the apparatus according to the present invention to achieve a decisive improvement in the problems described above and thus to raise essentially the level of prior art. In order to carryout this aim, the method and apparatus according to the invention are mainly characterized by what has been presented in the characterizing parts of the independent claims directed thereto.

As the most important advantages of the method and apparatus according to the invention may be mentioned simplicity and efficiency of the technique related thereto as well as use of the same, thanks to which it is possible to improve significantly the functionality of clarification tanks e.g. being used in the handling of waste water also for the part of the removal of clarified liquid. The efficiency of the invention is based especially on the fact that surface water of the liquid basin is allowed to flow unobstructed continuously in the same direction through the whole length of the clarifying section of the liquid basin. As water does not get to a stagnant state on the surface of the liquid basin, no growth will be born, because the flow carries along with it surface water of the whole liquid basin as it is continuously in movement. Thanks to this, the need for cleaning the liquid exhaust arrangement can be minimized or even completely eliminated.

When the exhaust passages or exhaust tubes or channels, having e.g. a circular or angular cross section, are located underneath liquid surface according to the invention, water drifting therein does not cause significant harm due to noise, which is furthermore possible to minimize e.g. with a noise reduction board, flap or the like attached to a coupling pipe that connects a collector funnel belonging to the exhaust organs to the exhaust passage.

The exhaust organs being movable according to the invention can first of all be coupled in a movable manner with a fixed exhaust passage in order to carry out their desired turning motion. As a more advantageous embodiment in practise they have, however, been coupled in a fixed manner with an exhaust passage that turns around its longitudinal axis in order to carry out movement of the exhaust organs by rotating the exhaust passage. The exhaust organs are advantageously arranged to function automatically e.g. according to alteration of the water level in a way that the flow of surface water can be carried out in a steady and continuous manner in order to remove clarified liquid so that a greater alteration of water level is enabled than with traditional technique.

Furthermore as an advantage of the invention may be mentioned thanks to the exhaust passages being situated underneath water surface that the strain (pressure) caused thereto from water is very low as water carries them. Thanks to this, the exhaust passages may be manufactured e.g. from glass fibre or different plastics, wherein the costs of e.g. the composition of the machinery of the liquid basin can be significantly decreased. Respectively, the edge shape of the exhaust organ's collector funnels can be manufactured e.g. from plastic with injection moulding to be as flexible as possible, so that water in the clarification tank does not stay still under any conditions, but instead either flows rapidly into the funnel or runs along with surface water without stops.

Therefore, thanks to the invention, it is furthermore possible to utilize in the clarifying section, instead of constructions e.g. made of speciality metal, significantly cheaper plastic based or composite structured materials that endure very different kinds of chemicals.

Thanks to the invention it is also possible to control passage of the flow of the liquid surface in different parts of the clarifying section, when needed, by using the exhaust organs of consequent exhaust passages in different positions with respect to each other. Thanks to the invention it is also possible to clean the exhaust organs according to need by moving them e.g. mechanically and/or in an auxiliary powered manner back and forth in the liquid basin over certain periods of time.

Other advantageous embodiments of the method and apparatus according to the invention have been presented in the dependent claims directed thereto.

In the following description the invention is being depicted in detail with reference to the appended drawings, whereby

in FIGS. 1a, 1b

are shown a partly (for the part of chains and scraper bars) stripped view from above and a longitudinal cross section view of a traditional liquid basin, in which the removal of clarified liquid is carried out according to prior art,

in FIGS. 2a, 2b

are shown a partly stripped view from above and a longitudinal cross section view of an alternative solution with respect to the one shown in FIGS. 1a, 1b in removal of clarified liquid according to prior art,

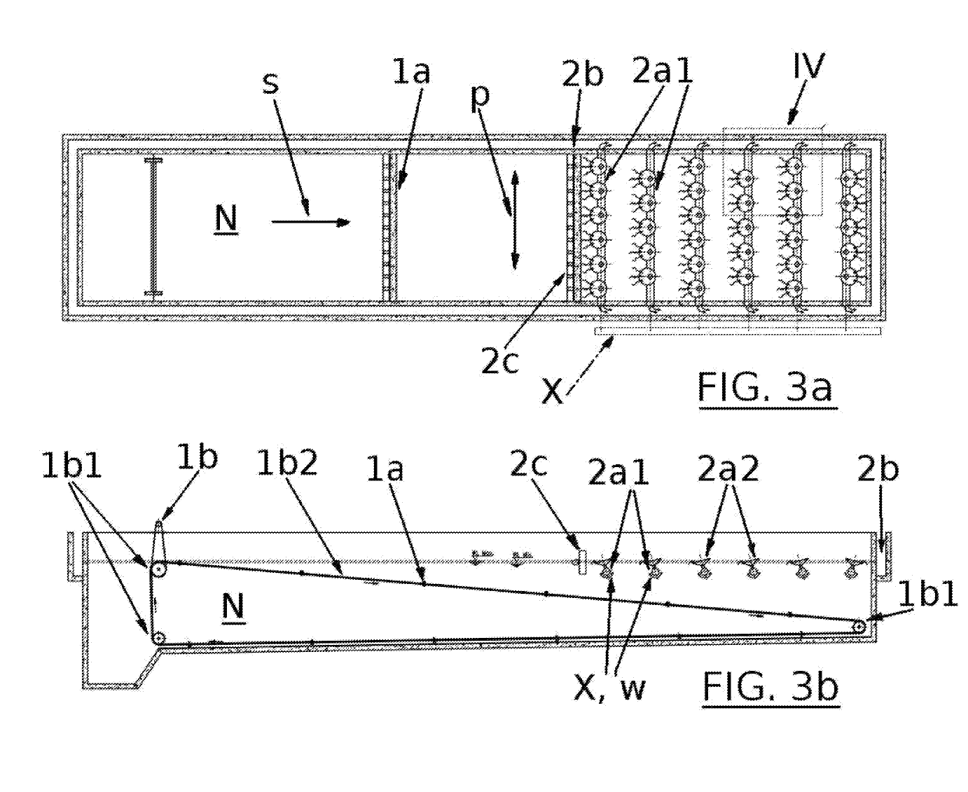

in FIGS. 3a, 3b

are shown a partly stripped view from above and a longitudinal cross section view of an advantageous liquid basin, in which the removal of clarified liquid is carried out according to the invention,

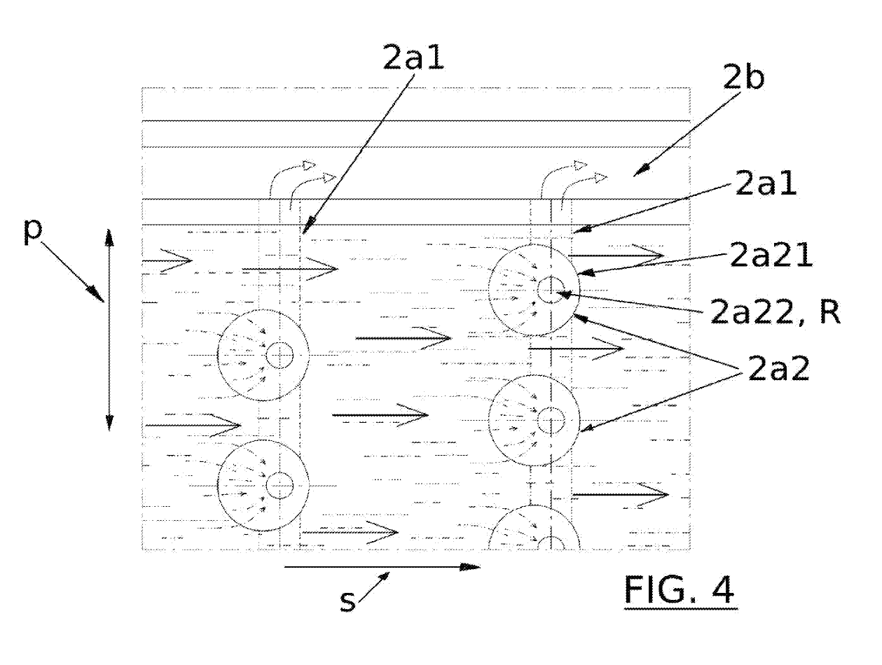

in FIG. 4

is shown an enlarged detail of point IV in FIG. 3a,

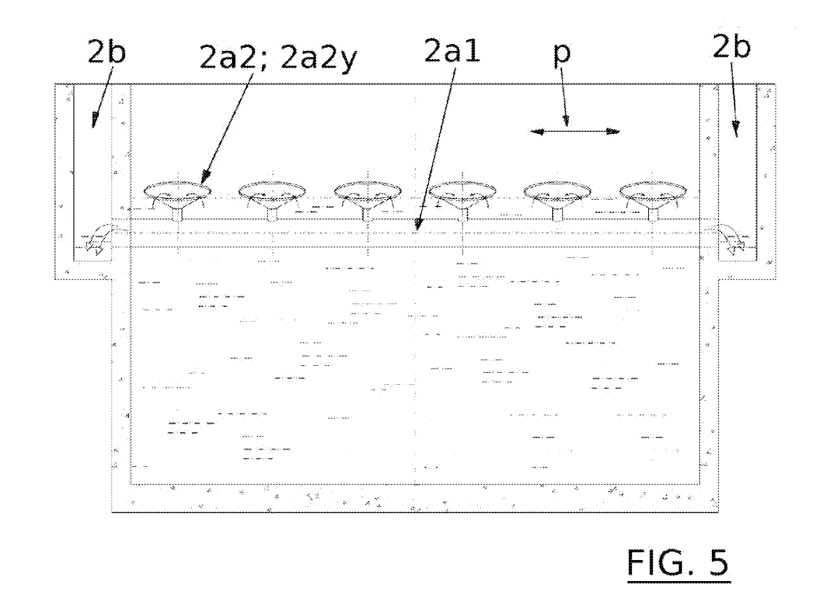

in FIG. 5

is shown a cross section of an advantageous embodiment according to the invention, when viewed from the front of an exhaust passage in the liquid basin,

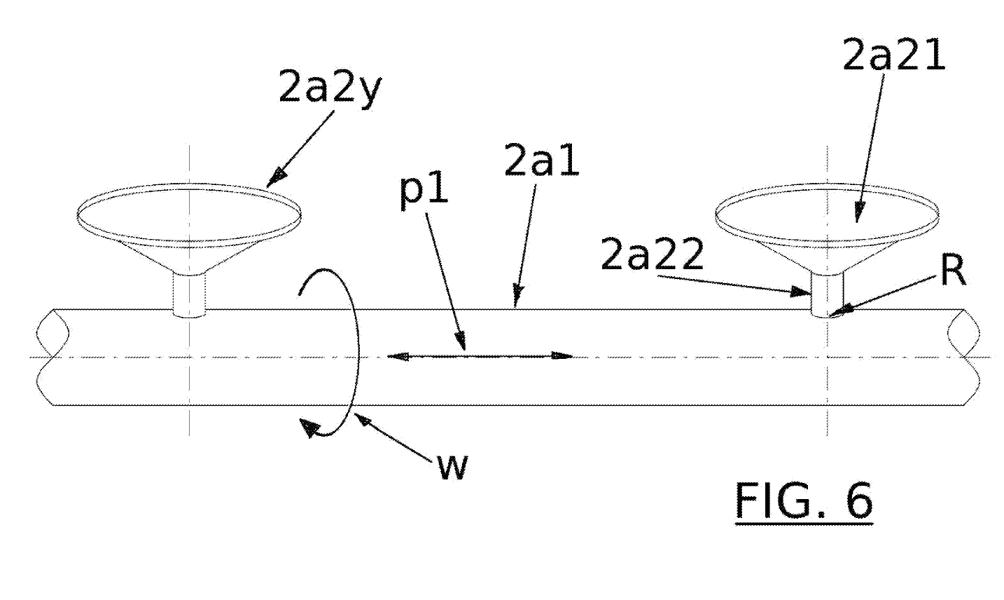

in FIG. 6

is shown a perspective view of an advantageous pipe-like exhaust passage belonging to an apparatus according to the invention and partly funnel-like exhaust organs, being coupled therewith, and

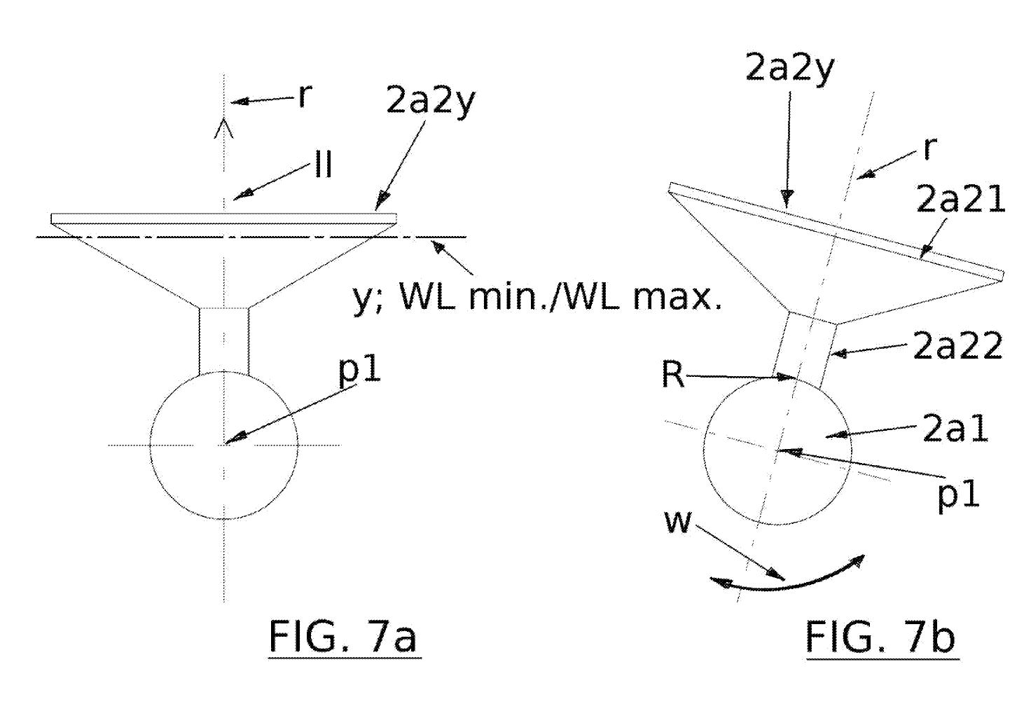

in FIGS. 7a, 7b

is shown a front view of the embodiment according to FIG. 6 in a vertical position and in a tilted position.

The invention relates first of all to a method for removal of clarified liquid from a liquid basin N, such as a clarification basin or like, with an apparatus, by means of which clarified liquid is being removed by using a liquid exhaust arrangement 2 and a collecting arrangement 2b coupled therewith. The liquid exhaust arrangement comprises one or more exhaust passages 2a1, existing beneath surface y of the liquid basin one after another in longitudinal direction s of the liquid basin and comprising a profile with an essentially closed cross section, such as a pipe, channel or like, each passage having a perforation R to make possible flow of liquid inside the same. Functioning of the liquid exhaust arrangement 2 is being controlled according to the circumstances, such as due to surface alteration in the liquid basin, by adjusting the amount of liquid to be removed by the exhaust passage 2a1 by changing a flow cross section area beneath the surface y of the liquid basin of an open overflow edge 2a2y of exhaust organs 2a2, each one of which being coupled with the perforation R in the exhaust passage and having a cross section expanding towards outer end thereof, which is carried out e.g. on the principle shown in FIGS. 3b and 7b by turning w the exhaust organs 2a2 with respect to longitudinal axis p1 of the exhaust passage 2a1.

In the method according to the invention especially with reference to FIGS. 3a, 3b and 4, clarified liquid is being removed in a spot-like manner at different points in crosswise direction p by at least two exhaust passages 2a1, being placed one after another in the longitudinal direction s of the liquid basin, whereby the exhaust organs 2a2 in each exhaust passage 2a1 are placed, when viewed in a plane of the liquid basin, in an overlapping manner with respect to each other.

In FIGS. 3a, 3b is shown an advantageous embodiment of the method according to the invention in a clarification tank that is carried out according to traditional technique, where, according to FIGS. 1a, 1b and 2a, 1b showing prior art, a scraper bar arrangement 1 has been utilized, which consists of one or more in the longitudinal direction s of the liquid basin consecutive scraper bars 1a, being is arranged movable with a circulating motion in opposite directions in the liquid basin by movement means 1b, such as by one or more chains 1b2 being fastened thereto and driven by a drive wheel and an idle wheel assembly 1b1 or the like.

As an advantageous embodiment of the method according to the invention, in order to prevent collecting of substance on the surface of the liquid basin, liquid on the surface is being removed by one or more exhaust passages 2a1, the exhaust organs 2a2 in which are in a differing position, such as oppositely directed, with respect to other exhaust organs in the same exhaust passage or in other exhaust passages. The above mentioned principle manifests itself especially in FIGS. 3a, 3b, according to which, the exhaust organs 2a2 of the hindmost exhaust passage 2a1 at the back wall of the liquid basin N are tilted towards the back wall, wherein the meaning is especially to prevent material from gathering on the surface of the liquid basin in connection with the back wall, whereby due to bumping into which the surface liquid might remain whirling and collecting material on its surface. Thanks to the method according to the invention, it is thus also possible to adjust the flow speed in different parts of the liquid basin according to need by using e.g. consecutive exhaust passages and/or the exhaust organs therein in different positions with respect to each other.

As a furthermore advantageous embodiment of the method according to the invention, removal of surface liquid through one or more exhaust passages 2a1 is being interrupted by turning the exhaust organs 2a2 of the exhaust passage 2a1 in question in accordance to what has been shown in FIG. 7a in a vertical position II reaching essentially above the surface y of the liquid basin. In this manner, it is possible to control the fluctuation of liquid surface especially in situations, where the liquid surface is at its lowest, wherein surface liquid can be removed if necessary e.g. by only using the hindmost exhaust passage and possibly in its backwards tilted position.

On the other hand, the invention also relates to an apparatus for removal of clarified liquid from a liquid basin N, such as a clarification basin or like, which apparatus has a liquid exhaust arrangement 2 for removing of clarified liquid and a collecting arrangement 2b coupled therewith. The liquid exhaust arrangement comprises one or more exhaust passages 2a1, existing beneath surface y of the liquid basin one after another in longitudinal direction s of the liquid basin and comprising a profile with an essentially closed cross section, such as a pipe, channel or like, each passage having a perforation R to make possible flow of liquid inside the same. The apparatus comprises an adjustment arrangement X for controlling functioning of the liquid exhaust arrangement 2 according to the circumstances, such as due to surface alteration in the liquid basin, which adjustment arrangement comprises mechanical and/or auxiliary powered driving means (which are, however, not shown in the figures) in order to adjust the amount of liquid to be removed by the exhaust passage 2a1 by changing a flow cross section area beneath the surface y of the liquid basin of an open overflow edge 2a2y of exhaust organs 2a2, being coupled with the perforation R in the exhaust passage and having a cross section expanding towards outer end thereof, which is carried out by turning w the exhaust organs 2a2 e.g. on the principle manifesting itself in FIGS. 3b and 7b with respect to longitudinal axis p1 of the exhaust passage 2a1.

The liquid removal arrangement 2 of the apparatus according to the invention comprises at least two exhaust passages 2a1, being placed one after another in the longitudinal direction s of the liquid basin, whereby the exhaust organs 2a2 in each exhaust passage 2a1 are placed, when viewed on a plane of the liquid basin, in an overlapping manner with respect to each other in order to remove clarified liquid in a spot-like manner at different points in crosswise direction p. Thus, an undisrupted and in a uniform manner continuing flow way for the surface liquid over the whole length of the clarifying section is made possible and kept as constant as possible.

As an advantageous embodiment of the apparatus according to the invention, the exhaust passage 2a1 belonging thereto comprises exhaust organs 2a2, being fastened immovably to the perforation R that exists in the exhaust passage in one and the same line, wherein the exhaust organs are arranged movable by rotating w the exhaust passage 2a1 in a vertical plane along the longitudinal direction s of the liquid basin around longitudinal axis p1 thereof.

As a furthermore advantageous embodiment of the apparatus according to the invention, the exhaust passage 2a1 belonging thereto has exhaust organs 2a2 reaching essentially above the surface y of the liquid basin in order to interrupt removal of surface liquid by turning the exhaust passage 2a1 in question in a vertical position II according to FIG. 7a.

As a furthermore advantageous embodiment of the apparatus according to the invention, the adjustment arrangement X comprises control and adjustment automation operable through auxiliary powered actuators in order to adjust turning motion of the exhaust organs 2a2, such as the rotating motion w of each exhaust passage 2a1, according to the circumstances, such as in order to control alteration of the surface level in the liquid basin and/or flow circumstances therein, by using the successive exhaust passages and/or the exhaust organs therein in positions differing from each other.

Particularly in FIGS. 3a, 3b is shown also an exhaust arrangement 2c, which, however, needs not to be utilized in all contexts. In addition, in FIG. 3b is shown a guide L in connection with the back wall of the liquid basin, the purpose of which is, when needed, to prevent the material on the bottom from drifting up to the liquid surface in connection with the back wall of the liquid basin due scraper bars 1a going down to the bottom of the liquid basin after an idle wheel 1b1.

Furthermore, in the advantageous embodiment shown especially in FIGS. 3a, 3b, the apparatus comprises a scraper bar arrangement 1, which consists of one or more scraper bars 1a, existing in crosswise direction p one after another in the longitudinal direction s of the liquid basin and being arranged movable with a circulating motion in opposite directions in the liquid basin by movement means 1b, such as one or more chains 1b2 coupled in connection therewith that are driven by a drive wheel and an idle wheel assembly or like.

It is clear that the invention is not limited to the embodiments presented or described above, but instead it can be modified within the basic idea of the invention in very many ways depending on the needs at any given time. Thus, the invention also relates at its widest to basins, which do not necessarily have any kind of an arrangement for removal of surface scum or a scraper bar arrangement e.g. according to FIGS. 3a, 3b. It is possible to vary the technical implementation of the overflow arrangement for the removal of surface scum, if such is, however, needed. Naturally there are also different kinds of scraper bar constructions, in addition to which in connection with the same can be used e.g. urethane based or the like filling materials etc. Thanks to the advantageous operating principle of the invention, it is, according to what has been said above, possible to manufacture the liquid removing machinery from the most varied materials with the most varied manufacturing techniques using plastic, metal or composite materials or if necessary or, if the circumstances so demand, by using more traditional metal or concrete structures etc. The principle according to the invention may naturally also be exploited by using longitudinal exhaust passages in the liquid basin, the exhaust organs therein turning in transverse plane with respect to the longitudinal direction of the liquid basin. In this type of a solution, it is furthermore possible to utilize exhaust passages that are coupled only from one end thereof with the back wall of the liquid basin.

1. Method for removal of clarified liquid from a liquid basin, such as a clarification basin or like, with an apparatus, by means of which clarified liquid is being removed by using a liquid exhaust arrangement and a collecting arrangement coupled therewith, whereby the liquid exhaust arrangement comprises one or more exhaust passages, existing beneath surface of the liquid basin one after another in longitudinal direction of the liquid basin and comprising a profile with an essentially closed cross section, such as a pipe, channel or like, each passage having a perforation to make possible flow of liquid inside the same, and whereby functioning of the liquid exhaust arrangement is being controlled according to the circumstances, such as due to surface alteration in the liquid basin, by adjusting the amount of liquid to be removed by an exhaust passage by changing a flow cross section area beneath the surface of the liquid basin of an open overflow edge of exhaust organs, being coupled with the perforation in the exhaust passage and having a cross section expanding towards outer end thereof, which is carried out by turning the exhaust organs with respect to longitudinal axis of the exhaust passage, wherein, clarified liquid is being removed in a spot-like manner at different points in crosswise direction by at least two exhaust passages, being placed one after another in the longitudinal direction of the liquid basin, whereby the exhaust organs in each exhaust passage are placed, when viewed on a plane of the liquid basin, in an overlapping manner with respect to each other.

2. Method according to claim 1, wherein in order to prevent gathering of substance on the surface of the liquid basin, liquid on the surface is being removed by one or more exhaust passages, the exhaust organs in which are in a differing position, such as oppositely directed, with respect to other exhaust organs in the same exhaust passage or in other exhaust passages.

3. Method according to claim 1, wherein, removal of surface liquid through one or more exhaust passages is being interrupted by turning the exhaust organs of the exhaust passage in question in a vertical position reaching essentially above the surface of the liquid basin.

4. Apparatus for removal of clarified liquid from a liquid basin, such as a clarification basin or like, which apparatus has a liquid exhaust arrangement for removing of clarified liquid and a collecting arrangement coupled therewith, whereby the liquid exhaust arrangement comprises one or more exhaust passages, existing beneath surface of the liquid basin one after another in longitudinal direction of the liquid basin and comprising a profile with an essentially closed cross section, such as a pipe, channel or like, each passage having a perforation to make possible flow of liquid inside the same, and wherein the apparatus comprises an adjustment arrangement for controlling functioning of the liquid exhaust arrangement according to the circumstances, such as due to surface alteration in the liquid basin, which adjustment arrangement comprises mechanical and/or auxiliary powered driving means in order to adjust the amount of liquid to be removed by an exhaust passage by changing a flow cross section area beneath the surface of the liquid basin of an open overflow edge of exhaust organs, being coupled with the perforation in the exhaust passage and having a cross section expanding towards outer end thereof, which is carried out by turning the exhaust organs with respect to longitudinal axis of the exhaust passage, wherein, the apparatus comprises at least two exhaust passages, being placed one after another in the longitudinal direction of the liquid basin, whereby the exhaust organs in each exhaust passage are placed, when viewed on a plane of the liquid basin, in an overlapping manner with respect to each other in order to remove clarified liquid in a spot-like manner at different points in crosswise direction.

5. Apparatus according to claim 4, wherein, the exhaust passage comprises exhaust organs, being fastened immovably to the perforation that exists in the exhaust passage in one and the same line, wherein the exhaust organs are arranged movable by rotating the exhaust passage in a vertical plane along the longitudinal direction of the liquid basin around longitudinal axis thereof.

6. Apparatus according to claim 4 or 5, wherein, the exhaust passage belonging thereto has exhaust organs reaching essentially above the surface of the liquid basin in order to interrupt removal of surface liquid by turning the exhaust passage in question in a vertical position.

7. Apparatus according to claim 4, wherein, the adjustment arrangement comprises control and adjustment automation operable through auxiliary powered actuators in order to adjust turning motion of the exhaust organs, such as the rotating motion of each exhaust passage, according to the circumstances, such as in order to control the surface level in the liquid basin and/or flow circumstances therein, by using the successive exhaust passages and/or the exhaust organs therein in positions differing from each other.

8. Apparatus according to claim 4, wherein, it comprises a scraper bar arrangement, which consists of one or more scraper bars, existing in crosswise direction one after another in the longitudinal direction of the liquid basin and being arranged movable with a circulating motion in opposite directions in the liquid basin by movement means such as one or more chains coupled in connection therewith that are driven through a drive wheel and idle wheel assembly or like.
